(19) United States
(12) Patent Application Publication
(10) Pub. No.: US 2026/0302491 A1
(43) Pub. Date: Oct. 1, 2026

(54) BATTERY MODULE

(71) Applicant: HONDA MOTOR CO., LTD., Tokyo (JP)

(72) Inventor: Yushi ASABA, Saitama (JP)

(21) Appl. No.: 19/576,857

(22) Filed: Mar. 24, 2026

(30) Foreign Application Priority Data
Mar. 27, 2025 (JP) 2025-053910

(51) Int. Cl. H01M 50/262; H01M 50/204

(52) U.S. Cl. CPC H01M 50/262; H01M 50/204

(57) ABSTRACT

The present invention provides a battery module capable of reliably preventing spatter from entering battery cells with a simple configuration. A battery module includes: a plurality of battery cells stacked side by side; an end plate disposed on an end side of the battery cells in a stacking direction; a bind member disposed on an end side of the battery cells orthogonal to the stacking direction; and a welded portion that welds the end plate and the bind member. The bind member includes a seal member provided on a side facing the end plate, and the end plate includes a groove capable of accommodating at least a part of the seal member. The groove is disposed on an inner side in the stacking direction relative to the welded portion. The welded portion and the seal member are disposed at overlapping positions, as viewed from the stacking direction.

This application is based on and claims the benefit of priority from Japanese application No. 2025-053910 filed on Mar. 27, 2025, the content of which is incorporated herein by reference.

### BACKGROUND OF THE INVENTION

### Field of the Invention

The present invention relates to a battery module.

### Related Art

In recent years, research and development have been conducted on battery modules that contribute to energy efficiency so that a greater number of people can have access to affordable, reliable, sustainable, and advanced energy sources. As a known battery module, there is one in which battery cells stacked in one direction are accommodated within a housing formed by an end plate and a bind member (see, for example, Japanese Unexamined Patent Application, Publication No. 2020-107476).

Patent Document 1: Japanese Unexamined Patent Application, Publication No. 2020-107476

### SUMMARY OF THE INVENTION

When the end plate and the bind member are connected by welding, spatter is generated. In the technology disclosed in Japanese Unexamined Patent Application, Publication No. 2020-107476, another member is disposed between the end plate and the bind member to prevent the spatter from entering the battery cell side. However, when another member is placed inside the housing space, there arises a problem that the configuration of the battery cells is restricted. Accordingly, there is a demand for reliably preventing spatter from entering the battery cells with a simpler configuration and thereby achieving improved energy efficiency.

(1) The present invention provides a battery module including: a plurality of battery cells (for example, battery cells 10) stacked side by side; an end plate (for example, an end plate 2) disposed on an end side of the battery cells in a stacking direction; a bind member (for example, a bind member 3) disposed on an end side of the battery cells in a direction orthogonal to the stacking direction; and a welded portion (for example, a welded portion 4) that welds the end plate and the bind member. The bind member includes a seal member (for example, a seal member 5) provided on a side facing the end plate. The end plate includes a groove (for example, a groove 24) capable of accommodating at least a part of the seal member. The groove is disposed on an inner side in the stacking direction relative to the welded portion. The welded portion and the seal member are disposed at overlapping positions, as viewed from the stacking direction.

(2) The groove is preferably formed in an arc shape in a cross-sectional view.

(3) The groove preferably has a ratio of depth to width between 3/0.47 and 3/0.59 inclusive, in a cross-sectional view.

(4) The groove is preferably formed by plastic working.

According to the aspect (1), since the groove 24 is disposed on the inner side in the stacking direction L, and the welded portion 4 and the seal member 5 are disposed at overlapping positions as viewed from the stacking direction L, the seal member 5 disposed in the groove 24 blocks the spatter 7 generated when the end plate 2 and the bind member 3 are welded to the welded portion 4. Accordingly, the spatter 7 is prevented from affecting the battery cell 10a disposed on the inner side in the stacking direction L. Furthermore, by forming the groove 24 in the end plate 2 and filling the groove 24 with the seal member 5, when the bind member 3 is welded to the end plate 2, a jig for pressing the bind member 3 can be supported in a region between the groove 24 in a flat portion 22 and an inner end of the end plate 2 in the stacking direction L, thereby preventing the bind member 3 from bending.

According to the aspect (2), since the groove 24 is formed in an arc shape, a space capable of accommodating the seal member 5 can be formed with fewer steps, resulting in excellent productivity and workability.

According to the aspect (3), even when the groove 24 has the largest volume and the seal member 5 has the smallest volume, a gap of approximately 0.1 mm between the bind member 3 and the end plate 2 can be maintained. Furthermore, even when the groove 24 has the smallest volume and the seal member 5 has the largest volume, the filling ratio of the seal member 5 can be controlled so as not to exceed 100% when the gap between the bind member 3 and the end plate 2 becomes zero.

According to the aspect (4), productivity can be improved without impairing the strength and durability of the end plate 2.

### BRIEF DESCRIPTION OF THE DRAWINGS

FIG. 1 is a perspective view illustrating a battery module according to the present embodiment;

FIG. 2 is a schematic view illustrating a peripheral portion of an end plate according to the present embodiment, as viewed from a cross-sectional direction;

FIG. 3 is a diagram illustrating a state before pressing of a seal member in a groove according to the present embodiment;

FIG. 4 is a diagram illustrating a state before pressing of the seal member according to the present embodiment;

FIG. 5 is a diagram illustrating a state after pressing of the seal member in the groove according to the present embodiment;

FIG. 6 is a schematic view illustrating a peripheral portion of a groove according to another embodiment, as viewed from the cross-sectional direction; and

FIG. 7 is a schematic view illustrating a peripheral portion of an end plate according to a conventional art, as viewed from the cross-sectional direction.

### DETAILED DESCRIPTION OF THE INVENTION

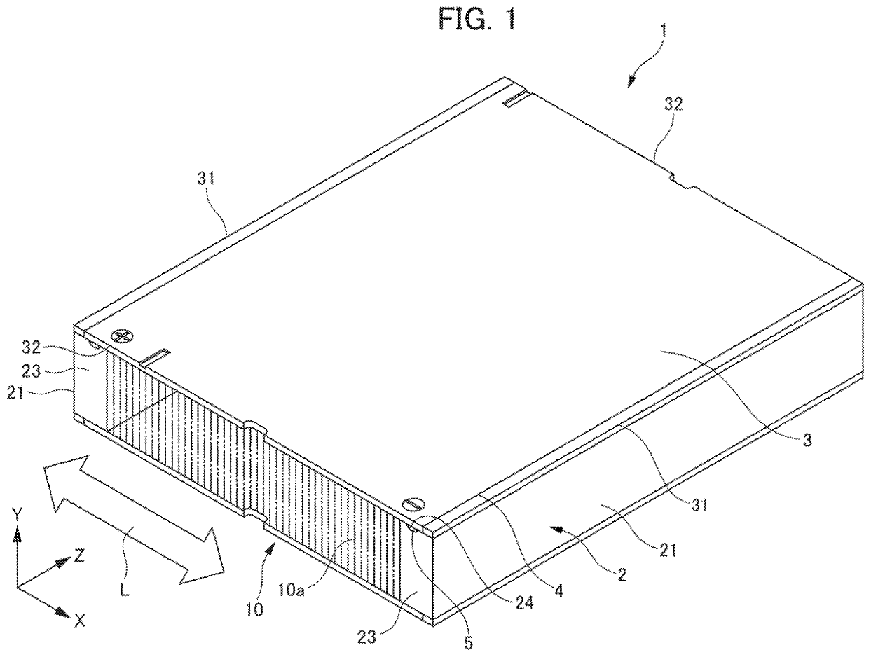

Hereinafter, embodiments of the present disclosure will be described in detail with reference to the drawings. As illustrated in FIG. 1, a battery module 1 according to the present embodiment includes a plurality of battery cells 10, an end plate 2, a bind member 3, a welded portion 4, and a seal member 5. The battery module 1 is used for applications requiring high current and high voltage, such as for motor drive systems of electric vehicles or hybrid electric vehicles.

The plurality of battery cells 10 are secondary batteries, and each battery cell 10a has a substantially rectangular parallelepiped shape. The battery cells 10a are disposed as stacked side by side. The hollow arrow illustrated in FIG. 1 indicates a stacking direction L in which the battery cells 10a are stacked. The stacking direction L extends along the X-direction in FIG. 1. In this specification, an end side of the battery module 1 in the stacking direction L is referred to as an outer side, and a central side away from the end side is referred to as an inner side in the stacking direction.

The end plates 2 are disposed on both end sides of the plurality of battery cells 10 in the stacking direction L and are arranged alongside the lateral surfaces of the battery cells 10a positioned outermost in the stacking direction L. Each end plate 2 is a substantially rectangular plate-shaped member made of, for example, metal. The end plate 2 is arranged such that the longitudinal direction thereof extends in a direction orthogonal to the stacking direction L. The end plate 2 includes a lateral surface portion 21, a flat portion 22, an end surface portion 23, and a groove 24.

The lateral surface portion 21 is a vertically elongated plate surface forming an outer lateral surface of the battery module 1. The flat portion 22 extends along upper and lower ends of the lateral surface portion 21. The upper side in the Y-direction illustrated in FIG. 1 forms an upper surface, and the lower side forms a lower surface. Both the upper and lower surfaces of the flat portion 22 are covered by the bind members 3 described later. The end surface portion 23 is a surface located at one end and the other end in the Z-direction illustrated in FIG. 1.

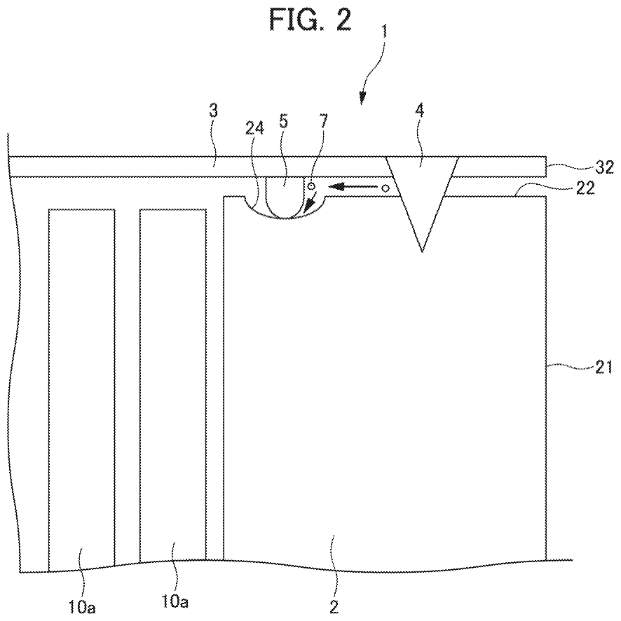

FIG. 2 is a schematic view illustrating a peripheral portion of the end plate 2, as viewed from the cross-sectional direction, with a simplified scale different from that of FIG. 1. The cross-sectional direction refers to the Z-direction illustrated in FIG. 1, extending horizontally and orthogonally to the stacking direction L. The term “cross-sectional view” refers to a view observed from the Z-direction. FIG. 2 illustrates a state during welding.

As illustrated in FIG. 2, the groove 24 is formed in the flat portion 22 of the end plate 2 and is constituted by a recessed portion in which part of the flat portion 22 is depressed. The groove 24 is formed linearly along a direction orthogonal to the stacking direction L, that is, along a direction in which the lateral surface portion 21 of the end plate 2 extends, and continuously extends from one end to the other end of the end plate 2. The groove 24 is formed in an arc shape in a cross-sectional view by plastic working, such as press forming of metal. As illustrated in FIG. 2, the groove 24 has a shallow, wide arc shape, and details such as the dimensions thereof will be described later. In the cross-sectional view, the groove 24 is positioned on an inner side (a side closer to the center) in the stacking direction L relative to the welded portion 4 described later.

As illustrated in FIG. 1, the bind members 3 constitute upper and lower surfaces of the battery module 1. Each bind member 3 is disposed on an end side of the battery cells 10 in a direction orthogonal to the stacking direction L and substantially perpendicular thereto, that is, on an upper end side or a lower end side of the battery cells 10a as illustrated in FIG. 1. The bind member 3 is a plate-shaped member disposed so as to extend over the upper and lower flat portions 22 of the respective end plates 2 located on both sides in the stacking direction L. The bind member 3 is a substantially rectangular plate-shaped member made of, for example, metal. An internal space surrounded by the bind members 3 and the end plates 2 forms a housing space for accommodating the battery cells 10. As for the bind member 3, a pair of first edges 31 are arranged along the stacking direction L, and a pair of second edges 32 orthogonal to the first edges 31 are arranged along the Z-direction orthogonal to the stacking direction L. The bind member 3 is welded to the flat portion of the end plate 2.

The welded portion 4 is a portion where the end plate 2 and the bind member 3 are welded together. As illustrated in FIG. 1, the welded portion 4 is disposed at a position spaced inward from the outer edge along the second edge 32 of the bind member 3 and is formed along a direction in which the second edge 32 of the bind member 3 and the lateral surface portion 21 of the end plate 2 extend. The welded portion 4 extends continuously from one end to the other end of the second edge 32 of the bind member 3, and the length thereof is, for example, between 550 mm and 570 mm inclusive. The end plate 2 and the bind member 3 may be welded, for example, using a fiber laser of a type that utilizes a laser medium composed of an optical fiber doped with a rare-earth element.

The seal member 5 is applied and provided on a side of the bind member 3 facing the end plate 2 so as to protrude from the bind member 3 toward the end plate 2. At least a part of the seal member 5 is accommodated in the groove 24 of the end plate 2 and is continuously disposed along the second edge 32 of the bind member 3. As illustrated in FIG. 2, the seal member 5 is disposed at a position overlapping the welded portion 4, as viewed from the stacking direction L. That is, when viewed from the outer side toward the inner side in the stacking direction L of the battery module 1, the welded portion 4 is located on the outer side, and the seal member 5 is located on the inner side. The seal member 5 is, for example, a moisture-curable resin and adheres to both the bind member 3 and the end plate 2. As the bind member 3 is connected to the end plate 2 by welding, the seal member 5 is filled into the groove 24.

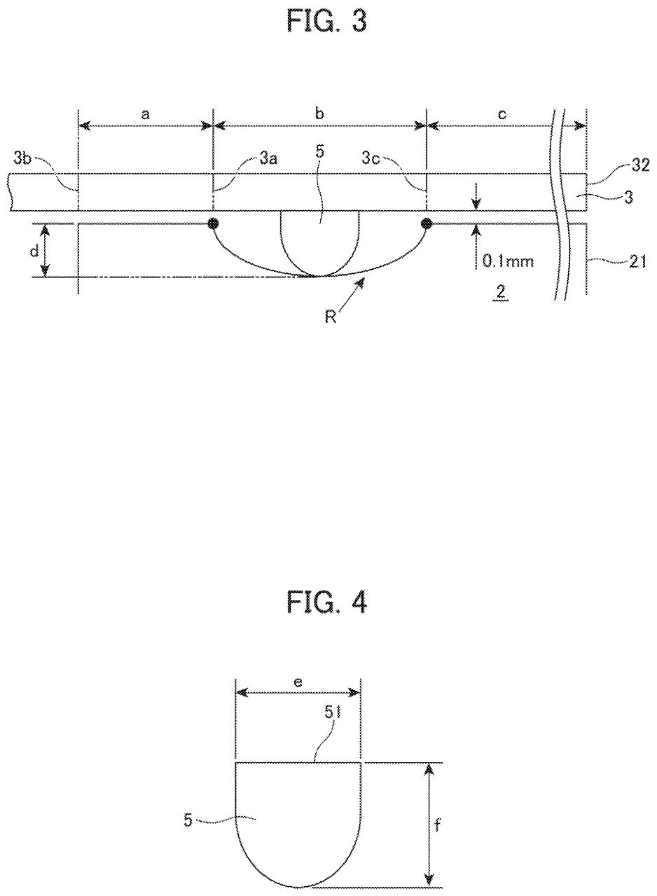

Table 1 illustrates an example of dimensions (in mm) illustrated in FIG. 3. However, these numerical values are not limited thereto. FIG. 3 is an enlarged schematic view illustrating a portion where the groove 24 is formed in the flat portion 22 (upper surface) of the end plate 2.

TABLE 1

| | a | b | c | d | e | f |
|---|---|---|---|---|---|---|
| DIMENSION (mm) | 1 | 3 | 8 | 0.5 | 0.9 | 0.6 |

As illustrated in Table 1 and FIG. 3, the groove 24 has a width b and a depth d. The width b is a distance connecting the ends of the flat portion 22 where the recess of the groove 24 begins. The depth d is a distance between the flat portion 22 and a point on the bottom side of the groove 24 farthest from the flat portion 22. A ratio of the depth d to the width b is preferably between 3/0.47 and 3/0.59 inclusive, and one example thereof is 3/0.5. By setting the shape within this range, the seal member 5 can be suitably filled into the groove 24.

As illustrated in FIG. 3, a dimension a is a distance in the bind member 3 between a position 3a corresponding to an inner end of the groove 24 of the end plate 2 facing the bind member in the stacking direction L and a position 3b corresponding to an inner end of the flat portion 22 of the end plate 2 in the stacking direction L. The dimension a is preferably between 0.8 mm and 1.2 mm inclusive, more preferably between 0.9 mm and 1.1 mm inclusive, and one example thereof is 1 mm.

A dimension c is a distance from a position corresponding to an outer end of the groove 24 of the end plate 2 facing the bind member in the stacking direction L to an outer edge of the second edge 32. The dimension c is preferably between 7.8 mm and 8.2 mm inclusive, more preferably between 7.9 mm and 8.1 mm inclusive, and one example thereof is 8 mm.

A width e is a width of a surface 51 of the seal member 5 in contact with the bind member 3 in a state where the seal member 5 is not deformed by pressing or the like. The width e is preferably between 0.7 mm and 1.1 mm inclusive, more preferably between 0.8 mm and 1.0 mm inclusive, and one example thereof is 0.9 mm.

A height f is a protruding height of the seal member 5 in a state where the seal member 5 is not deformed by pressing or the like, and is defined as a distance from the surface 51 in contact with the bind member 3 to the farthest end of the seal member 5. The height f is preferably between 0.4 mm and 0.8 mm inclusive, more preferably between 0.5 mm and 0.7 mm inclusive, and one example thereof is 0.6 mm.

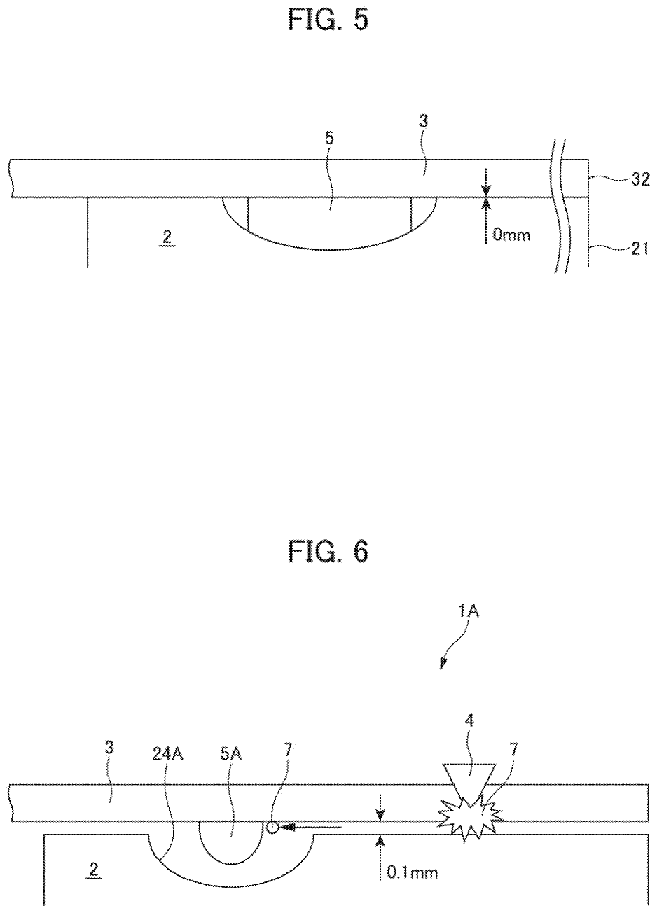

As illustrated in FIG. 4, in a state where the seal member 5 is applied to the bind member 3, the seal member 5 has dimensions of the width e and the height f. However, as illustrated in FIG. 3, when the space between the bind member 3 and the end plate 2 becomes narrower with a gap of approximately 0.1 mm, for example, the seal member 5 is pressed against the bottom of the groove 24 and deforms. When the bind member 3 is further pressed against the end plate 2, the seal member 5 expands and fills the groove 24, as illustrated in FIG. 5. At this time, the application amount of the seal member 5 is adjusted so that the filling ratio becomes between 95% and 98% inclusive of a space surrounded by the bind member 3 and the groove 24.

As indicated by the fine arrow directions in FIG. 2, when the bind member 3 is welded to the end plate 2, there is a concern that the spatter 7 generated by the welding may fly toward the inner side in the stacking direction L and enter a space in which the battery cells 10 are accommodated. However, since the seal member 5 is positioned on the inner side in the stacking direction L relative to the welded portion 4, the spatter 7 is blocked by the seal member 5.

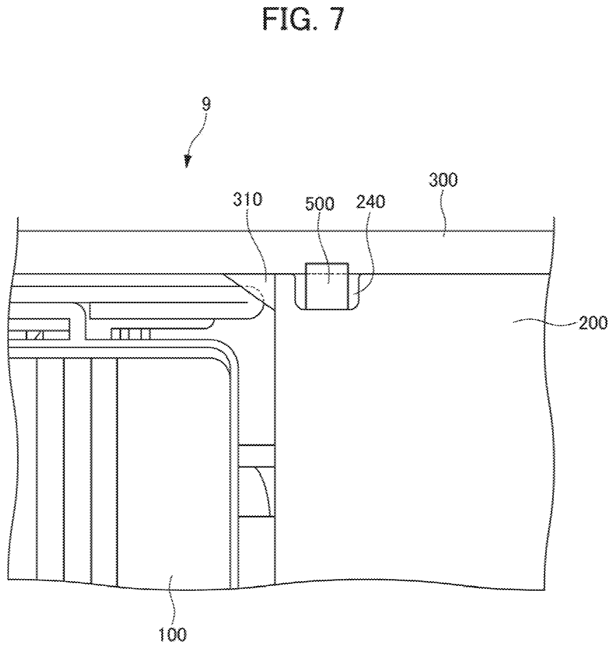

FIG. 7 illustrates a battery module 9 according to a conventional art. As illustrated in FIG. 7, in some cases, a groove 240 formed in an end plate 200 is not arcuate but formed, for example, in a substantially U-shape or another shape with an upper side open. If the groove 240 is not arcuate, formation becomes difficult. For example, when cutting with a laser or the like, the laser cutter must reciprocate for cutting, unlike the case of forming an arc shape, which increases labor and cost. Further, when attempting to dispose a member 310 that prevents intrusion of spatter 7 inside the end plate 200, instead of or in addition to a seal member 500 inside the housing space, the member 310 may interfere with a cell 100 accommodated inside the housing space.

According to the present embodiment, the following effects can be achieved.

(1) The battery module 1 is configured to include: the plurality of battery cells 10a stacked side by side; the end plate 2 disposed on the end side of the battery cells 10a in the stacking direction L; the bind member 3 disposed on the end side of the battery cells 10a orthogonal to the stacking direction L; and the welded portion 4 that welds the end plate 2 and the bind member 3. The bind member 3 is configured to include the seal member 5 provided on the side facing the end plate 2. The end plate 2 is configured to include the groove 24 capable of accommodating at least a part of the seal member 5. The groove 24 is disposed on the inner side in the stacking direction L relative to the welded portion 4. The welded portion 4 and the seal member 5 are disposed at overlapping positions, as viewed from the stacking direction L.

Since the groove 24 is disposed on the inner side in the stacking direction L, and the welded portion 4 and the seal member 5 are disposed at overlapping positions as viewed from the stacking direction L, the seal member 5 disposed in the groove 24 blocks the spatter 7 generated when the end plate 2 and the bind member 3 are welded to the welded portion 4. Accordingly, the spatter 7 is prevented from affecting the battery cell 10a disposed on the inner side in the stacking direction L. Furthermore, by forming the groove 24 in the end plate 2 and filling the groove 24 with the seal member 5, when the bind member 3 is welded to the end plate 2, a jig for pressing the bind member 3 can be supported in a region between the groove 24 in the flat portion 22 and an inner end of the end plate 2 in the stacking direction L, thereby preventing the bind member 3 from bending.

(2) According to the present embodiment, the groove 24 is formed in an arc shape in a cross-sectional view. Since the groove 24 is formed in an arc shape, a space capable of accommodating the seal member 5 can be formed with fewer steps, resulting in excellent productivity and workability.

(3) According to the present embodiment, the groove 24 has a ratio of depth to width between 3/0.47 and 3/0.59 inclusive, in a cross-sectional view. With this ratio, even when the groove 24 has the largest volume and the seal member 5 has the smallest volume, a gap of approximately 0.1 mm between the bind member 3 and the end plate 2 can be maintained. Furthermore, even when the groove 24 has the smallest volume and the seal member 5 has the largest volume, the filling ratio of the seal member 5 can be controlled so as not to exceed 100% when the gap between the bind member 3 and the end plate 2 becomes zero.

(4) According to the present embodiment, the groove 24 is formed by plastic working. Therefore, productivity can be improved without impairing the strength and durability of the end plate 2.

It should be understood that the present invention is not limited to the above-described embodiment, and various modifications and improvements may be included within the scope of the present invention as long as the object of the invention can be achieved. The battery cells 10 may be of any type, provided that the battery cells are arranged in a stacked configuration in one direction. In addition, the welded portion and the seal member are not limited to being formed continuously, but may also be formed in a partially discontinuous manner.

FIG. 6 is a diagram illustrating a groove 24A of a battery module 1A according to another embodiment, as viewed from the cross-sectional direction. The amount and shape of filling of the seal member are not limited to those described in the above embodiment, as long as at least a part of the seal member is accommodated in the groove. As illustrated in FIG. 6, a seal member 5A may be joined to a side of the bind member 3 facing the end plate 2 and may protrude toward the groove 24A to a degree sufficient to block the spatter 7. For example, when a gap between the end plate 2 and the bind member 3 is assumed to be approximately 0.1 mm, it is sufficient for the protruding dimension to be greater than 0.1 mm.

### EXPLANATION OF REFERENCE NUMERALS

1: battery module
2: end plate
3: bind member
4: welded portion
5: seal member
24: groove
10a: each battery cell
10: battery cell

What is claimed is:

1. A battery module, comprising:
a plurality of battery cells stacked side by side;
an end plate disposed on an end side of the battery cells in a stacking direction;
a bind member disposed on an end side of the battery cells orthogonal to the stacking direction; and
a welded portion that welds the end plate and the bind member,
wherein the bind member includes a seal member provided on a side facing the end plate,
the end plate includes a groove capable of accommodating at least a part of the seal member,
the groove is disposed on an inner side in the stacking direction relative to the welded portion, and
the welded portion and the seal member are disposed at overlapping positions, as viewed from the stacking direction.

2. The battery module according to claim 1, wherein the groove is formed in an arc shape in a cross-sectional view.

3. The battery module according to claim 1, wherein the groove has a ratio of depth to width between 3/0.47 and 3/0.59 inclusive, in a cross-sectional view.

4. The battery module according to claim 2, wherein the groove has a ratio of depth to width between 3/0.47 and 3/0.59 inclusive, in a cross-sectional view.

5. The battery module according to claim 1, wherein the groove is formed by plastic working.

6. The battery module according to claim 2, wherein the groove is formed by plastic working.
